(19) United States
(12) Patent Application Publication
(10) Pub. No.: US 2025/0303668 A1
(43) Pub. Date: Oct. 2, 2025

(54) CARBON FIBER STRUCTURAL MEMBER AND WEARABLE DEVICE

(71) Applicant: GOERTEK TECHNOLOGY CO., LTD, Qingdao (CN)

(72) Inventors: Xiongchun DU, Qingdao (CN); Chao ZHANG, Qingdao (CN)

(21) Appl. No.: 19/238,990

(22) Filed: Jun. 16, 2025

Related U.S. Application Data
(63) Continuation of application No. PCT/CN2024/108174, filed on Jul. 29, 2024.

(30) Foreign Application Priority Data
Nov. 8, 2023 (CN) 202311483125.X

(51) Int. Cl. B32B 5/26; B32B 3/14

(52) U.S. Cl. CPC B32B 5/262; B32B 3/14; B32B 2250/20; B32B 2250/40; B32B 2262/106; B32B 2307/51; B32B 2437/00

(57) ABSTRACT

A carbon fiber structural member and a wearable device are provided. The carbon fiber structural member includes a fixed section, a deformable section and at least one splicing ply. The splicing ply includes a first carbon fiber ply provided in the fixed section and a second carbon fiber ply provided in the deformable section. The carbon fibers of the second carbon fiber ply are perpendicular to the longitudinal direction of the carbon fiber structural member, and the first carbon fiber ply in at least one of the splicing plies is a carbon fiber woven material or the carbon fibers of the first carbon fiber ply is extended at least along the longitudinal direction of the carbon fiber structural member.

### CROSS-REFERENCE TO RELATED APPLICATIONS

This application is a continuation application of International Application No. PCT/CN2024/108174, filed on Jul. 29, 2024, which claims priority to Chinese Patent Application No. 202311483125.X, filed on Nov. 8, 2023. The disclosures of the above-mentioned applications are incorporated herein by reference in their entireties.

### TECHNICAL FIELD

The present application relates to the technical field of composite materials, and in particular relates to a carbon fiber structural member and a wearable device.

### BACKGROUND

Smart wearable products such as virtual reality (VR) devices and augmented reality (AR) devices become more and more popular, and because smart wearable products need to be worn on the head for a long time, the demand for wearing comfort of smart wearable products is increasingly higher. Due to the differences in head size among different users, the temples or nose rests need to have a certain degree of elastic deformation.

Currently, wearable products are designed in the form of glasses or helmets. In related arts, considering the strength requirements and lightweight requirements of the structure, the temples and frames are mainly made of plastic materials such as PC, PC/ABS, and PA. However, due to the limitations of the molding process, most of them require injection molding, so the wall thickness of the temples and frames is thick, the overall structure is heavy, and the elastic deformation ability is poor.

Carbon fiber composite materials, due to their high strength and low density, can meet the weight and strength requirements of wearable products with a very thin wall thickness, which has great advantages and can meet the high strength and lightweight design requirements of product structural members. However, carbon fiber is relatively brittle, has a strong bending performance, and is easy to break when bent.

### SUMMARY

The main purpose of the present application is to provide a carbon fiber structural member and a wearable device, aiming to improve the deformation ability of the structural member in the wearable device and improve the applicability and reliability of the wearable device.

To achieve the above purpose, the present application provides a carbon fiber structural member, including a fixed section; a deformable section connected with the fixed section along a longitudinal direction of the carbon fiber structural member; and at least one splicing ply, the splicing ply including a first carbon fiber ply provided in the fixed section and a second carbon fiber ply provided in the deformable section; carbon fibers of the second carbon fiber ply are perpendicular to the longitudinal direction of the carbon fiber structural member, and the first carbon fiber ply in the at least one splicing ply is a carbon fiber woven material or carbon fibers of the first carbon fiber ply are extended at least along the longitudinal direction of the carbon fiber structural member.

In an embodiment of the present application, the carbon fiber structural member further includes at least one carbon fiber continuous layer, and the carbon fiber continuous layer is provided on a surface of at least one side of the carbon fiber structural member.

In an embodiment of the present application, the carbon fiber structural member includes two carbon fiber continuous layers, and the splicing ply is sandwiched between the two carbon fiber continuous layers.

In an embodiment of the present application, the carbon fiber structural member includes two splicing plies, and splicing positions of two adjacent splicing plies are staggered.

In an embodiment of the present application, the carbon fiber structural member includes at least three splicing plies, one of the splicing plies is sandwiched between other splicing plies and serves as a middle splicing ply, and splicing positions of each of the splicing plies at either side of the middle splicing ply are sequentially staggered toward a side of the second carbon fiber ply; or

the splicing positions of the splicing plies are sequentially staggered along the longitudinal direction of the carbon fiber structural member.

In an embodiment of the present application, at least a portion of a splicing boundary between the first carbon fiber ply and the second carbon fiber ply is provided at an angle to a width direction of the splicing ply.

In an embodiment of the present application, one of the first carbon fiber ply and the second carbon fiber ply is provided with a splicing interface, and another of the first carbon fiber ply and the second carbon fiber ply is provided with a splicing portion that matches a shape of the splicing interface, and the splicing portion is embedded in the splicing interface.

In an embodiment of the present application, the splicing interface is provided with a shrinking section, and the shrinking section is in a shrinking state toward an opening of the splicing interface.

In an embodiment of the present application, layup angles of the first carbon fiber layers in two adjacent splicing plies are different.

In an embodiment of the present application, the second carbon fiber ply of the at least one splicing ply includes at least one elastic region and at least one connecting region provided along a width direction; carbon fibers in the elastic region are perpendicular to the longitudinal direction of the carbon fiber structural member, and a layup angle of the connecting region is the same as the layup angle of the first carbon fiber ply.

In an embodiment of the present application, at least two second carbon fiber plies include the elastic region and the connecting region, and the connecting regions of the two second carbon fiber plies are staggered; and/or

the second carbon fiber ply includes two connecting regions and the elastic region provided between the two connecting regions; and/or

the second carbon fiber ply includes two elastic regions and the connecting region provided between the two elastic regions.

In an embodiment of the present application, an accommodating cavity is formed in the fixed section.

In an embodiment of the present application, a side wall of the fixed section is provided with an opening communicated with the accommodating cavity, and the carbon fiber structural member further includes a wave-transmitting material layer for covering an opening of the accommodating cavity.

The present application further provides a wearable device, including the carbon fiber structural member as described above.

The technical solution of the present application adopts a carbon fiber ply structure to make a structural member in a wearable device, which can meet the requirements of the wearable device for high strength and light weight of the structural member. The carbon fiber structural member includes a fixed section and a deformable section, and the carbon fiber structural member includes at least one splicing ply formed by splicing a first carbon fiber ply and a second carbon fiber ply, the first carbon fiber ply corresponds to the fixed section, and the layup angle of the first carbon fiber ply in at least one splicing ply is 0° or is set at an acute angle, and a carbon fiber woven layer can also be used, that is, the first carbon fiber ply has carbon fibers extending roughly along the longitudinal direction of the carbon fiber structural member, so that the fixed section has good structural strength and is not easy to bend.

The second carbon fiber ply corresponds to the deformable section, and the carbon fibers in the second carbon fiber ply are perpendicular to the longitudinal direction of the carbon fiber structural member, thereby improving the elastic deformation ability of the carbon fiber structural member in the deformable section, so that the deformable section has good elastic bending performance. With such an arrangement, when the carbon fiber structural member is used in a wearable device, the electrical components in the wearable device can be set in the fixed section of the carbon fiber structural member. The fixed section is not easy to bend, and can avoid damage to the electrical components. The deformable section has good elasticity, so that the carbon fiber structural member can be adaptively bent and deformed according to the size of the wearing position, thereby improving the applicability and reliability of the wearable device.

### BRIEF DESCRIPTION OF THE DRAWINGS

In order to more clearly illustrate the embodiments of the present application or the technical solutions in the related art, the drawings required for use in the embodiments or the description of the related art will be briefly introduced below. Obviously, the drawings described below are only some embodiments of the present application. For those skilled in the art other drawings can be obtained based on the structures shown in these drawings without creative work.

FIG. 1 is a structural schematic view of when a carbon fiber structural member is a temple according to an embodiment of the present application.

FIG. 2 is a cross-sectional view of the carbon fiber structural member in the length and thickness directions according to an embodiment of the present application.

FIG. 3 is a cross-sectional view of the carbon fiber structural member in the length and thickness directions according to an embodiment of the present application.

FIG. 4 is a cross-sectional view of the carbon fiber structural member in the length and thickness directions according to an embodiment of the present application.

FIG. 5 is a cross-sectional view of the carbon fiber structural member in the length and thickness directions according to an embodiment of the present application.

FIG. 6 is a cross-sectional view of the carbon fiber structural member in the length and thickness directions according to an embodiment of the present application.

FIG. 7 is a cross-sectional view of the carbon fiber structural member in the length and thickness directions according to an embodiment of the present application.

FIG. 8 is a structural schematic view of a splicing ply in the carbon fiber structural member according to an embodiment of the present application.

FIG. 9 is a structural schematic view of the splicing ply in the carbon fiber structural member according to an embodiment of the present application.

FIG. 10 is a structural schematic view of the splicing ply in the carbon fiber structural member according to an embodiment of the present application.

FIG. 11 is a structural schematic view of the splicing ply in the carbon fiber structural member according to an embodiment of the present application.

FIG. 12 is a structural schematic view of the splicing ply in the carbon fiber structural member according to an embodiment of the present application.

FIG. 13 is a structural schematic view of the splicing ply in the carbon fiber structural member according to an embodiment of the present application.

FIG. 14 is a structural schematic view of the splicing ply in the carbon fiber structural member according to an embodiment of the present application.

FIG. 15 is a structural schematic view of the splicing ply in the carbon fiber structural member according to an embodiment of the present application.

FIG. 16 is a structural schematic view of the splicing ply in the carbon fiber structural member according to an embodiment of the present application.

FIG. 17 is a structural schematic view of the splicing ply in the carbon fiber structural member according to an embodiment of the present application.

FIG. 18 is a cross-sectional view of the carbon fiber structural member at a deformable section along the width and thickness directions according to an embodiment of the present application.

FIG. 19 is a structural schematic view of when the carbon fiber structural member is a temple according to an embodiment of the present application.

FIG. 20 is a structural schematic view of when the carbon fiber structural member is a frame according to an embodiment of the present application.

FIG. 21 is a structural schematic view of when the carbon fiber structural member is a nose rest according to an embodiment of the present application.

FIG. 22 is a structural schematic view of when a wearable device is a headset according to an embodiment of the present application.

The realization of the objective, functional characteristics, and advantages of the present application are further described with reference to the accompanying drawings.

### DETAILED DESCRIPTION OF THE EMBODIMENTS

The following will be combined with the drawings in the embodiments of the present application to clearly and completely describe the technical solutions in the embodiments of the present application. Obviously, the described embodiments are only part of the embodiments of the present application, not all of the embodiments. Based on the embodiments of the present application, all other embodiments obtained by those skilled in the art without creative work are within the scope of protection of the present application.

It should be noted that all directional indications (such as up, down, left, right, front, back, etc.) in the embodiments of the present application are only used to explain the relative position relationship, movement status, etc. between the components under a certain specific posture (as shown in the accompanying drawings). If the specific posture changes, the directional indication will also change accordingly.

In the present application, unless otherwise clearly specified and limited, the terms “connection”, “fixation”, etc. should be understood in a broad sense. For example, “fixation” can be a fixed connection, a detachable connection, or an integral connection; it can be a mechanical connection or an electrical connection; it can be a direct connection or an indirect connection through an intermediate medium, it can be the internal connection of two elements or the interaction relationship between two elements, unless otherwise clearly defined. For those skilled in the art, the specific meanings of the above terms in the present application can be understood according to specific circumstances.

In addition, in the present application, descriptions such as “first”, “second”, etc. are only used for descriptive purposes and cannot be understood as indicating or implying their relative importance or implicitly indicating the number of the indicated technical features. Therefore, the features defined as “first” and “second” may explicitly or implicitly include at least one of the features. In addition, the technical solutions between the various embodiments can be combined with each other, but they must be based on the ability of those skilled in the art to implement them. When the combination of technical solutions is contradictory or cannot be implemented, it should be deemed that such a combination of technical solutions does not exist and is not within the scope of protection required by the present application.

The present application provides a carbon fiber structural member 10.

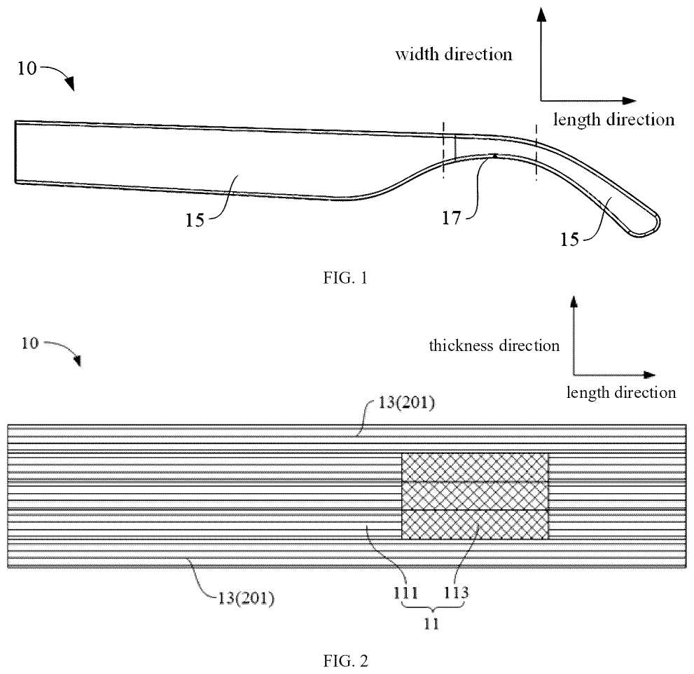

As shown in FIG. 1, FIG. 2, FIG. 8 and FIG. 9, in an embodiment of the present application, the carbon fiber structural member 10 includes a fixed section 15 and a deformable section 17 connected with the fixed section 15, and the fixed section 15 and deformable section 17 are provided along a longitudinal direction of the carbon fiber structural member 10.

The carbon fiber structural member 10 includes at least one splicing ply 11, and the splicing ply 11 includes a first carbon fiber ply 111 provided in the fixed section 15 and a second carbon fiber ply 113 provided in the deformable section 17, the carbon fibers of the second carbon fiber ply 113 are perpendicular to the longitudinal direction of the carbon fiber structural member 10, and the first carbon fiber ply 111 in the at least one splicing ply 11 is a carbon fiber woven material 202 or the carbon fibers of the first carbon fiber ply 111 are extended at least along the longitudinal direction of the carbon fiber structural member 10.

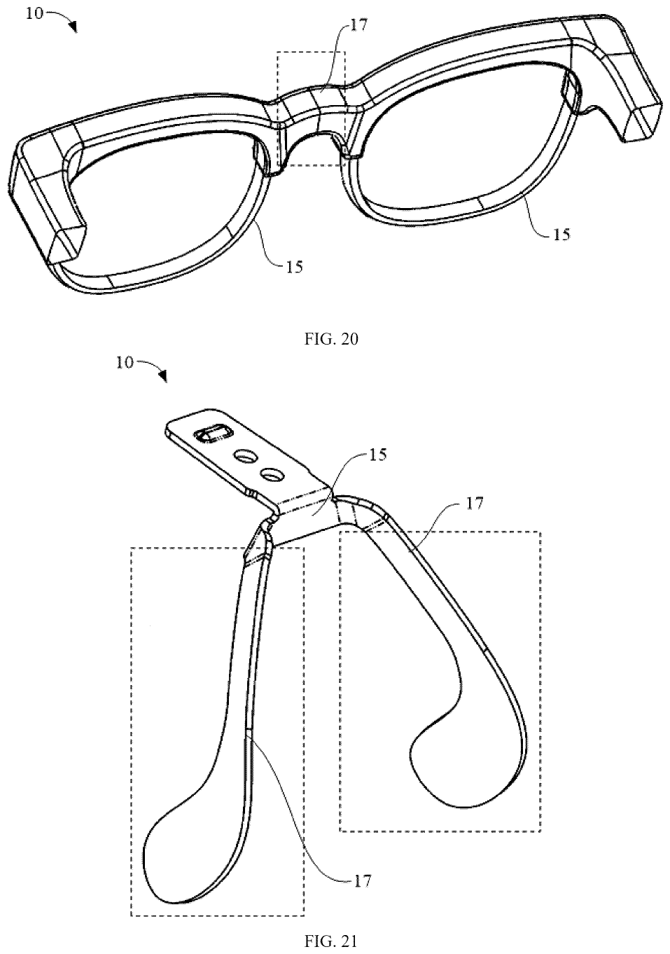

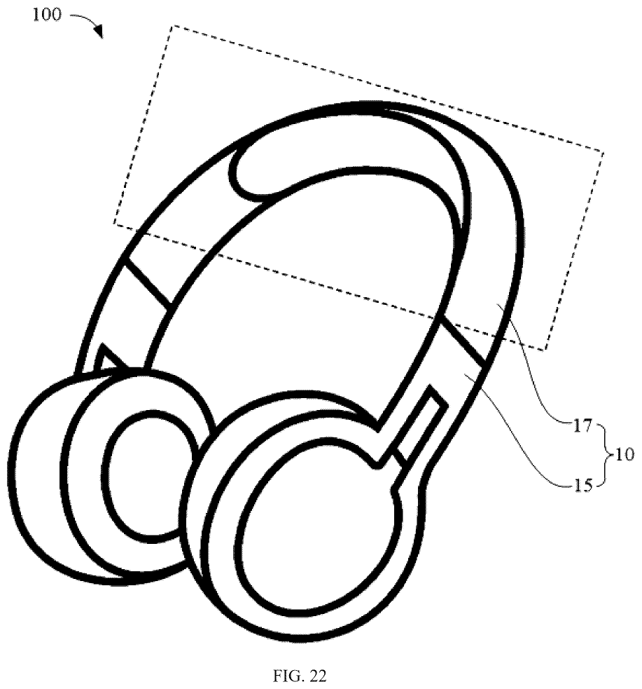

The carbon fiber structural member 10 proposed in the present application can be applied to a wearable device 100, such as a virtual reality device (VR), an augmented reality device (AR), a mixed reality device, and electronic devices such as headphones, and can also be a wearable product such as myopic glasses and sunglasses. The wearable device 100 includes but is not limited to glasses, masks or helmets. As shown in FIG. 19 to FIG. 22, the carbon fiber structural member 10 can be the temples and frames of glasses, the nose rests of glasses, masks or helmets, the headband of headsets, or the wristband of wrist-worn devices. It can also be the internal structural member of the temple or other structural members with deformation requirements in the wearable device 100.

The carbon fiber structural member 10 is a carbon fiber composite material member having the characteristics of high strength and light weight, and can better meet the requirements of electronic devices, especially wearable devices 100 such as head-mounted devices (such as VR devices, AR devices), for high strength and light weight of structural members.

The carbon fiber in the carbon fiber ply of the carbon fiber structural member 10 has a variety of strength grades to choose from, such as: T300 grade, T700 grade, etc. The carbon fiber ply can also use carbon fiber prepreg, which is to compound resin on carbon fiber. The resin can be thermoplastic resins, such as epoxy resin, PC, PA, PP, PEEK, PPS, etc. The resin can also be thermosetting plastics such as phenolic, amino or polyetherimide. The resin also has a variety of flame retardant grades to choose from, such as: [V2] flame retardant grade, [V0] flame retardant grade. The resin is used to wrap the carbon fiber ply. In this way, when the resin is cured, the carbon fiber ply is encapsulated inside the resin matrix to form the carbon fiber structural member 10.

The carbon fiber structural member 10 has strong anisotropy in mechanical properties in the longitudinal direction of the fiber and in the direction perpendicular to the fiber. Under forces in different directions, the material has different strength and stiffness performance. The bending strength of carbon fiber varies with the direction of the fiber. The bending performance of carbon fiber varies with the direction of fiber arrangement. The bending performance along the carbon fiber arrangement direction (longitudinal direction) is the strongest, and the bending performance perpendicular to the fiber arrangement direction (transverse direction) is weaker.

In the embodiment of the present application, the carbon fiber structural member 10 includes a fixed section 15 and a deformable section 17 connected with the fixed section, the arrangement direction of the fixed section 15 and the deformable section 17 is the longitudinal direction of the carbon fiber structural member 10, and the angle between the extension direction of the carbon fiber and the longitudinal direction is the layup angle of the carbon fiber. For example, if the extension direction of the carbon fiber in the carbon fiber ply is parallel to the longitudinal direction, the layup angle of the carbon fiber ply is 0°. If the extension direction of the carbon fiber in the carbon fiber ply is perpendicular to the longitudinal direction of the carbon fiber structural member 10, the layup angle of the carbon fiber ply is 90°.

The carbon fiber structural member 10 includes at least one splicing ply 11, and the splicing ply 11 includes a first carbon fiber ply 111 provided in the fixed section 15 and a second carbon fiber ply 113 provided in the deformable section 17. The first carbon fiber ply 111 can exist in the form of a carbon fiber unidirectional material 201 or in the form of a carbon fiber woven material 202 (for example, the woven texture adopts a 2×2 twill weave). When the first carbon fiber ply 111 is a carbon fiber unidirectional material 201, the carbon fibers of at least one first carbon fiber ply 111 is extended at least along the longitudinal direction of the carbon fiber structural member 10, that is, the carbon fibers of the first carbon fiber ply 111 is extended along the longitudinal direction of the carbon fiber structural member 10, and at this time, the layup angle of the first carbon fiber ply 111 is 0°. Alternatively, the carbon fibers of the first carbon fiber layer 111 have an extension tendency in both the longitudinal direction and the width direction of the carbon fiber structural member 10, so that the layup angle of the first carbon fiber layer 111 is an acute angle, for example, a layup angle of ±45°, or a layup angle of ±10°, ±30°, ±60°, ±80° or any other acute angle. In this way, since the carbon fiber filaments have high strength, rigidity and high bending performance, the fixed section 15 can have good rigidity and is not easy to bend and deform. Thus, when the carbon fiber structural member 10 of the embodiment of the present application is used in the wearable device 100, the electrical components of the wearable device 100 can be provided in the fixed section 15, so that the electrical components are not easily damaged by the bending of the carbon fiber structural member. It should be noted that when the layup angle of the first carbon fiber layer 111 is an acute angle, the layup angle of the first carbon fiber layer 111 can be set according to the required structural strength, and the carbon fibers in the first carbon fiber layer 111 need to extend roughly along the longitudinal direction of the carbon fiber structural member 10.

The carbon fibers of the second carbon fiber ply 113 are perpendicular to the longitudinal direction of the carbon fiber structural member 10, that is, the layup angle of the second carbon fiber ply 113 is 90°. It is understandable that due to possible processing errors, errors in the lamination and other factors, the carbon fibers of the second carbon fiber ply 113 may not be completely perpendicular to the longitudinal direction of the carbon fiber structural member 10, and there may be certain errors. It is only necessary to make the carbon fibers of the second carbon fiber ply 113 roughly perpendicular to the longitudinal direction of the carbon fiber structural member 10. For example, the layup angle of the second carbon fiber ply 113 can be ±89° and ±87°, etc., In this way, since the carbon fibers in the second carbon fiber ply 113 are provided along the longitudinal direction of the carbon fiber structural member 10, the bending performance of the deformable section 17 is improved, therefore, it is not easy to break and damage. That is, at this time, the bending performance of the carbon fiber structural member 10 on the deformable section 17 is stronger than that of the fixed section 15. The splicing method between the first carbon fiber ply 111 and the second carbon fiber ply 113 can be bonding, hot pressing connection, etc., which is not limited here.

In addition, it should be noted that the carbon fiber structural member 10 of the embodiment of the present application includes at least one fixed section 15 and at least one deformable section 17. That is, the carbon fiber structural member 10 may include not only one fixed section 15 and one deformable section 17. For example, the carbon fiber structural member 10 may include two fixed sections 15 and one deformable section 17, such as the temple of the glasses. In an embodiment, the front end of the temple is used to provide the computing unit and the acoustic component, and the tail of the temple is provided with a charging interface. Therefore, the front end and the tail of the temple both need to be designed with a rigid structure and are not allowed to deform. In order to adapt to the differences in head shapes of different people, the temple needs a certain amount of deformation, so a section between the front end and the tail of the temple is set as a deformable section, and the temple can be bent in the deformable section and is not easily broken. In addition, such as the frame of the glasses, the frame area for setting the lenses is not allowed to deform, and the connecting section connecting the two frame areas needs to have a certain amount of deformation. There are also structures such as the head beam of the headset, which can be set as the carbon fiber structural member 10 of the embodiment of the present application. The carbon fiber structural member 10 may also include two deformable sections 17 and a fixed section 15, such as a nose rest for glasses or a mask. The nose pads on both sides of the nose rests need to fit the nose shapes of different users, so a certain amount of deformation is required, and the connecting section connecting the two nose pads needs to be connected and fixed to the frame of the glasses or the cover of the mask, and deformation is not allowed.

The technical solution of the present application adopts a carbon fiber ply structure to make a structural member 10 in a wearable device 100, which can meet the requirements of the wearable device 100 for high strength and light weight of the structural member 10. The carbon fiber structural member 10 includes a fixed section 15 and a deformable section 17, and the carbon fiber structural member 10 includes at least one splicing ply 11 formed by splicing a first carbon fiber ply 111 and a second carbon fiber ply 113, the first carbon fiber ply 111 corresponds to the fixed section 15, and the layup angle of the first carbon fiber ply 111 in at least one splicing ply 11 is 0° or is set at an acute angle, and a carbon fiber woven layer can also be used, that is, the first carbon fiber ply 111 has carbon fibers extending roughly along the longitudinal direction of the carbon fiber structural member 10, so that the fixed section 15 has good structural strength and is not easy to bend.

The second carbon fiber ply 113 corresponds to the deformable section 17, and the carbon fibers in the second carbon fiber ply 113 are perpendicular to the longitudinal direction of the carbon fiber structural member 10, thereby improving the elastic deformation ability of the carbon fiber structural member 10 in the deformable section 17, so that the deformable section 17 has good elastic bending performance. With such an arrangement, when the carbon fiber structural member 10 is used in a wearable device 100, the electrical components in the wearable device 100 can be set in the fixed section 15 of the carbon fiber structural member 10. The fixed section 15 is not easy to bend, and can avoid damage to the electrical components. The deformable section 17 has good elasticity, so that the carbon fiber structural member 10 can be adaptively bent and deformed according to the size of the wearing position, thereby improving the applicability and reliability of the wearable device 100.

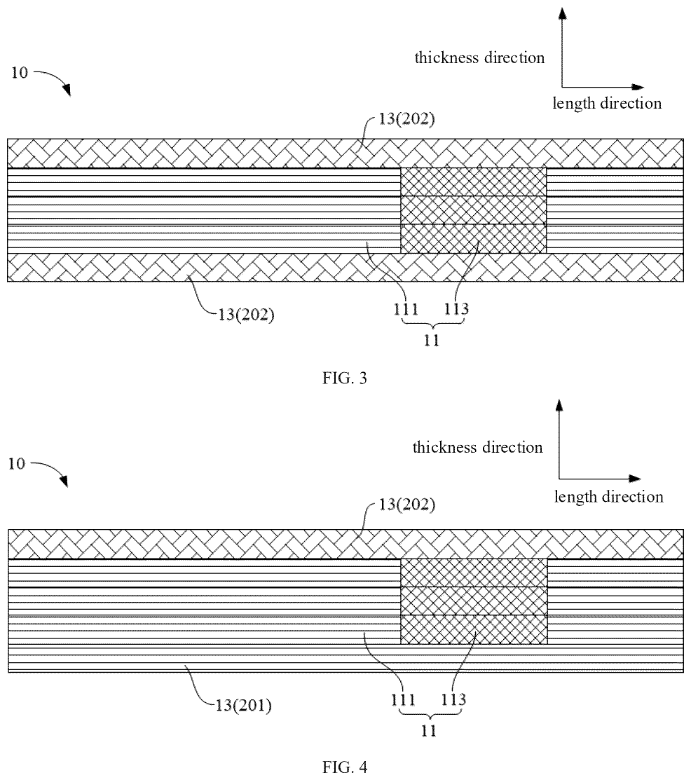

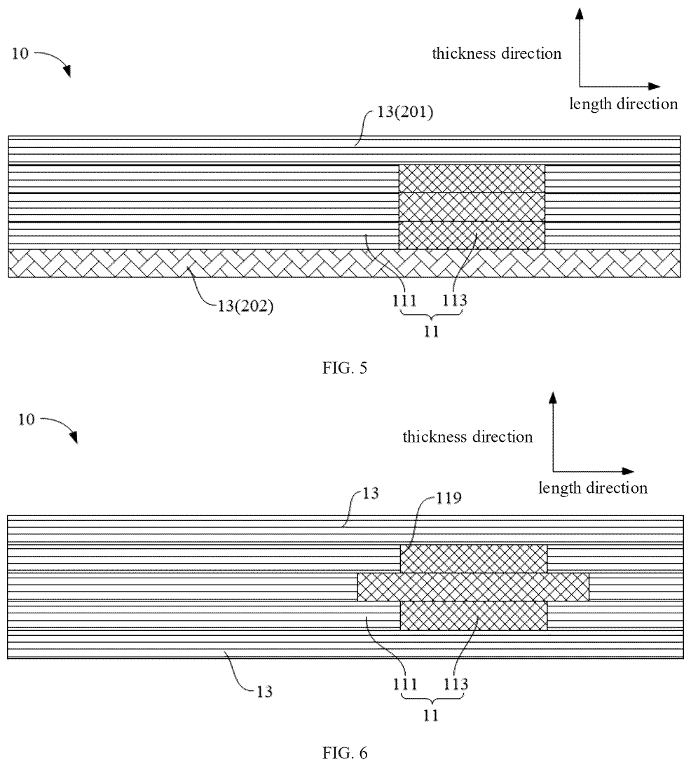

As shown in FIG. 2 to FIG. 5, in an embodiment of the present application, the carbon fiber structural member 10 includes at least one carbon fiber continuous layer 13, and the carbon fiber continuous layer is disposed on at least one side surface of the carbon fiber structural member 10.

In the embodiment of the present application, at least one side of the carbon fiber structural member 10 is provided with a carbon fiber continuous layer 13, and the carbon fibers on the carbon fiber continuous layer 13 are laid in the same direction. That is, the outermost layer of the carbon fiber structural member 10 is a complete carbon fiber layer, and the layup angle of the carbon fiber on the carbon fiber continuous layer 13 can be 0°, 90°, ±45° or other layup angles. The carbon fiber continuous layer can also be made of carbon fiber woven material, which is not limited here. By covering the complete carbon fiber continuous layer 13 on the first carbon fiber ply 111 and the second carbon fiber ply 113 of the splicing section can improve the structural strength of the carbon fiber structural member 10 and ensure the integrity of the outer side of the carbon fiber structural member 10, and avoid cracks at the splicing position that may cause damage to the carbon fiber structural member 10, such as cracking or warping.

It should be noted that in the embodiment of the present application, when the layup angle of the carbon fiber continuous layer 13 is not 90°, for example, the layup angle is 0°, ±10°, ±30°, ±45°, ±60°, ±80° or any other acute angle, or when the carbon fiber woven material 202 is used, it will have a certain impact on the elasticity of the deformable section 17. At this time, the thickness of the carbon fiber continuous layer 13 can be appropriately reduced, for example, the thickness of the carbon fiber continuous layer is made smaller than the thickness of the splicing ply 11, so as to ensure the elasticity of the deformable section 17 while making the outer side of the carbon fiber structural member 10 intact.

As shown in FIG. 2 to FIG. 5, in an embodiment of the present application, the carbon fiber structural member 10 includes two carbon fiber continuous layers 13, and the splicing ply 11 is sandwiched between the two carbon fiber continuous layers 13.

In the embodiment, a carbon fiber continuous layer 13 is provided on both sides of the carbon fiber structural member 10. This arrangement further improves the structural strength of the carbon fiber structural member 10 and ensures the integrity of each surface of the carbon fiber structural member 10, which avoids cracks at the splicing position that may lead to damage to the carbon fiber structural member 10, such as cracking or warping. The two carbon fiber continuous layers 13 may be carbon fiber unidirectional materials 201 with the same layup angle, or may be carbon fiber unidirectional materials 201 with different layup angles, or at least one of the carbon fiber continuous layers 13 may be a carbon fiber woven material 202, which is not limited here.

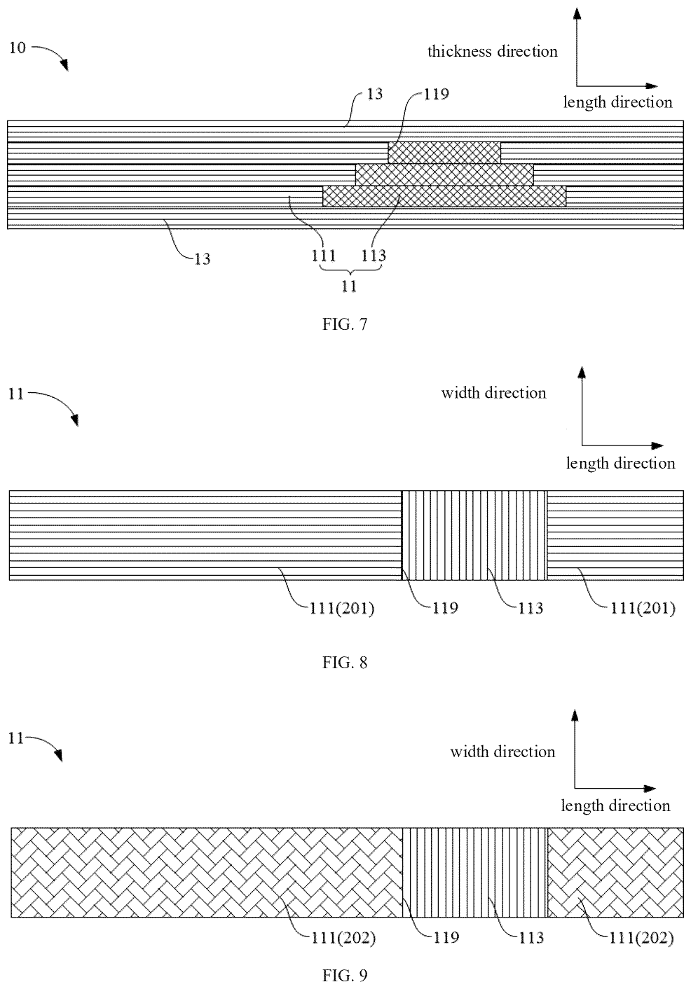

As shown in FIG. 6 and FIG. 7, in an embodiment of the present application, the carbon fiber structural member 10 includes at least two layers of the splicing plies 11, and the splicing positions of two adjacent splicing plies 11 are staggered.

In the embodiment, the carbon fiber structural member 10 is formed by stacking at least two splicing plies 11. Such a configuration can improve the structural strength of the carbon fiber structural member 10. In addition, the splicing positions of the two splicing plies 11 are staggered, so that the splicing position of any splicing ply 11 can be located on the bent first carbon fiber ply 111 or the second carbon fiber ply 113 of the other splicing ply 11, that is, the splicing position of any splicing ply 11 is limited by the other splicing ply 11, which can avoid the first carbon fiber ply 111 or the second carbon fiber ply 113 from warping and deformation at the splicing position, and can improve the reliability of the carbon fiber structure.

As shown in FIG. 6, in the embodiment of the present application, the carbon fiber structural member 10 includes at least three splicing plies 11, one of the splicing plies 11 is sandwiched between the other splicing plies 11 and serves as a middle splicing ply 11, and the splicing positions of each of the splicing plies 11 at either side of the middle splicing ply 11 are sequentially staggered toward the side of the second carbon fiber ply 113.

In the embodiment, the carbon fiber structural member 10 is formed by stacking at least three splicing plies 11, and such arrangement can improve the structural strength of the carbon fiber structural member 10. A layer of splicing ply 11 roughly provided in the middle in the thickness direction of the carbon fiber structural member 10 (i.e., the stacking direction of each splicing ply 11) serves as a middle layer splicing ply 11, and at least one splicing ply 11 is stacked on the upper and lower sides of the middle layer splicing ply 11. For example, if the carbon fiber structural member 10 includes three splicing plies 11, the splicing ply in the middle is the middle layer splicing ply 11. If the carbon fiber structural member 10 includes four splicing plies 11, any one of the middle two splicing plies 11 can be used as the middle splicing ply 11. The splicing positions of each of the splicing ply 11 on either side of the middle splicing ply 11 are sequentially staggered toward the side of the second carbon fiber ply 113. That is, on the upper side of the middle splicing ply 11, the splicing positions of each of the splicing ply 11 including the middle splicing ply 11 are sequentially staggered toward the side close to the second carbon fiber ply 113. Similarly, on the lower side of the middle splicing ply 11, the splicing positions of each of the splicing ply 11 including the middle splicing ply 11 are sequentially staggered toward the side close to the second carbon fiber ply 113. In this way, if the staggered distances of two adjacent splicing positions are consistent, the splicing positions of each splicing ply 11 in the carbon fiber structural member 10 can be symmetrically referenced by the middle splicing ply 11. The staggered distances of the splicing positions can also be inconsistent. In this way, the carbon fiber structural member 10 can be prevented from warping and deformation at the splicing positions during the molding process.

As shown in FIG. 7, in an embodiment of the present application, the splicing positions of the splicing plies 11 are sequentially staggered along the longitudinal direction of the carbon fiber structural member 10.

In the embodiment, the splicing positions of each splicing ply 11 in the carbon fiber structural member 10 are staggered from top to bottom along the longitudinal direction of the carbon fiber structural member 10, so that each first carbon fiber ply 111 and each second carbon fiber ply 113 are in a stepped structure, which can better realize the fiber ply transition design between the deformable section 17 and the fixed section 15, reduce the process difficulty caused by sudden changes in ply during molding, and improve molding convenience.

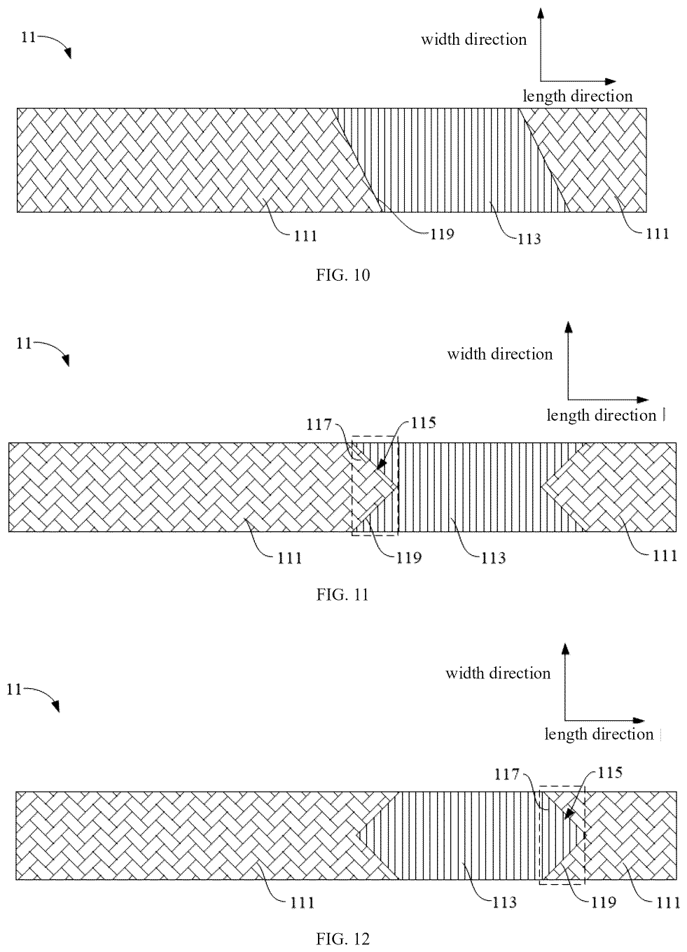

As shown in FIG. 10 to FIG. 15, in an embodiment of the present application, at least a portion of a splicing boundary 119 between the first carbon fiber ply 111 and the second carbon fiber ply 113 is provided at an angle to a width direction of the splicing ply 11.

In the embodiment, the direction perpendicular to the longitudinal direction of the carbon fiber structural member 10 on the carbon fiber ply plane is the width direction of the carbon fiber structural member 10. In the splicing ply 11, at least a portion of the splicing boundary 119 between the first carbon fiber ply 111 and the second carbon fiber ply 113 is provided at an angle to the width direction of the splicing ply 11. The entire splicing boundary 119 may be extended obliquely along the width direction of the splicing ply 11, or the splicing boundary 119 may be extended in a zigzag manner along the width direction of the carbon fiber structure member. For example, the splicing boundary 119 is provided to an undulating boundary that undulates in the longitudinal direction of the carbon fiber structural member 10, such as wave undulation, sawtooth undulation and other regular or irregular undulating boundaries. Or the splicing boundary 119 is provided to a stepped boundary, a circular boundary and other regular or irregular undulating boundaries. In this way, compared with the method of extending the splicing boundary 119 in a straight line along the width direction of the carbon fiber structural member 10, the connecting region 1133 between the first carbon fiber ply 111 and the second carbon fiber ply 113 is longer, thereby improving the connection strength between the first carbon fiber ply 111 and the second carbon fiber ply 113.

Since the layup angle of the second carbon fiber ply 113 is 90°, if the splicing boundary 119 extends in a straight line along the width direction of the carbon fiber structural member 10, only the carbon fiber filaments closest to the first carbon fiber ply 111 in the second carbon fiber ply 113 are connected to the first carbon fiber ply 111. When the splicing boundary 119 is extended, more carbon fiber filaments in the second carbon fiber ply 113 are connected to the first carbon fiber ply 111, which can also improve the connection strength between the first carbon fiber ply 111 and the second carbon fiber ply 113, thereby improving the overall structural reliability, and reducing the risk of cracking at the splicing position.

As shown in FIG. 11 to FIG. 15, in an embodiment of the present application, one of the first carbon fiber ply 111 and the second carbon fiber ply 113 is provided with a splicing interface 115, and the other one is provided with a splicing portion 117 that matches the shape of the splicing interface 115, and the splicing portion 117 is embedded in the splicing interface 115. That is, when the first carbon fiber ply is provided with a splicing interface, and the second carbon fiber ply is provided with a splicing portion, or when the second carbon fiber ply is provided with the splicing interface is provided with the splicing interface, then the first carbon fiber ply is provided with the splicing portion.

In the embodiment, a splicing interface 115 and a splicing portion 117 are provided at the splicing position between the first carbon fiber ply 111 and the second carbon fiber ply 113 in the splicing ply 11. The splicing interface 115 may be provided at the edge of the first carbon fiber ply 111, and the splicing portion 117 may be provided at the edge of the second carbon fiber ply 113; or the splicing interface 115 may be provided at the edge of the second carbon fiber ply 113, and the splicing portion 117 may be provided at the edge of the first carbon fiber ply 111. The shapes of the splicing portion 117 and the splicing interface 115 are adapted to each other, so that the splicing portion 117 is embedded in the splicing interface 115 and the edge of the splicing portion 117 is aligned with the edge of the splicing interface 115. By providing the splicing portion 117 and the splicing interface 115, a splicing boundary 119 between the first carbon fiber ply 111 and the second carbon fiber ply 113 forms a tortuous boundary, so that the connection strength between the first carbon fiber ply 111 and the second carbon fiber ply 113 can be improved. The shapes of the splicing interface 115 and the splicing interface 117 may be rectangular, circular, serrated, wavy, trapezoidal, or a combination of at least two of the above structures, or other regular or irregular shapes, which are not limited here.

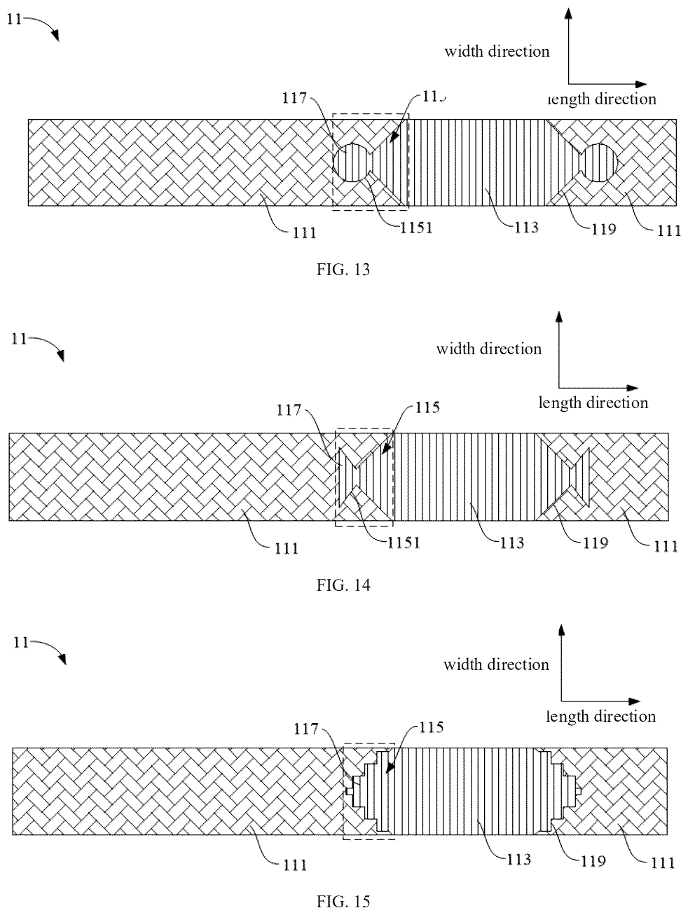

As shown in FIG. 13 and FIG. 14, in an embodiment of the present application, the splicing interface 115 has a shrinking section 1151, and the shrinking section 1151 is in a shrinking state toward the opening of the splicing interface 115.

In the embodiment, in the arrangement direction between the first carbon fiber ply 111 and the second carbon fiber ply 113 (i.e., the longitudinal direction of the carbon fiber structural member 10) the splicing interface 115 has a shrinking section 1151 with a shrinking width, and the shrinking section 1151 can be a structure that makes the splicing interface 115 as a whole gradually shrink in width. Or a section of the splicing interface 115 is used as a shrinking section. The shrinking section can be a dovetail groove, or an arc groove, or other regular or irregular shrinking structures. In this way, when the first carbon fiber ply 111 and the second carbon fiber ply 113 are spliced, the splicing portion 117 is embedded in the splicing interface 115. Due to the setting of the shrinking section, the splicing portion 117 is not easy to escape from the splicing interface 115 in the longitudinal direction of the carbon fiber structural member 10, which further improves the connection strength between the first carbon fiber ply 111 and the second carbon fiber ply 113, thereby improving the structural reliability of the splicing ply 11 and reducing the risk of the splicing ply 11 breaking when being pulled or bent.

In an embodiment, the layup angles of the first carbon fiber plies 111 in two adjacent splicing plies 11 are different.

In the embodiment, the carbon fiber structural member 10 is formed by stacking at least two splicing plies 11; such a configuration can improve the structural strength of the carbon fiber structural member 10. In addition, the layup angles of the first carbon fiber plies 111 in the two splicing plies 11 are different. For example, the layup angle of one of the first carbon fiber plies 111 can be 0°, and the layup angle of the other first carbon fiber ply 111 can be 90°, ±45° or other angles; or the layup angles of the two first carbon fiber plies 111 are 45° and −45° respectively; or one of the first carbon fiber plies can be made of carbon fiber unidirectional material 201, and the other first carbon fiber ply can be made of carbon fiber woven material 202. Taking the three-layer splicing plies 11 as an example, the layup angle can be ±45°, or the ply design can be 0°/90°/0° or 90°/0°/90°, or the carbon fiber woven material 202 can be used.

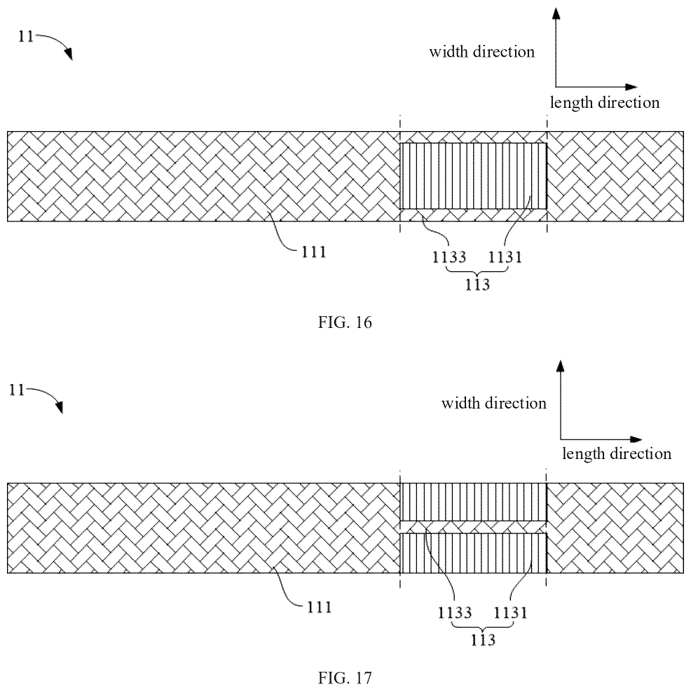

As shown in FIG. 16 and FIG. 17, in an embodiment of the present application, the second carbon fiber ply 113 of at least one of the splicing plies 11 includes at least one elastic region 1131 and at least one connecting region 1133 provided along the width direction; the carbon fibers of the elastic region 1131 are perpendicular to the longitudinal direction of the carbon fiber structural member 10, and the layup angle of the connecting region 1133 is the same as the layup angle of the first carbon fiber ply 111.

In the embodiment, in the splicing ply 11, the second carbon fiber ply 113 includes an elastic region 1131 and a connecting region 1133, and the elastic region 1131 and the connecting region 1133 are provided side by side in the width direction of the carbon fiber structural member 10. The carbon fiber layup angle in the elastic region 1131 is 90°, that is, perpendicular to the longitudinal direction of the carbon fiber structural member 10, so that the second carbon fiber ply 113 has a good elastic deformation ability, thereby improving the bending performance of the carbon fiber structural member 10 in the deformable section 17. The layup angle of the carbon fiber in the connecting region 1133 is consistent with the layup angle of the first carbon fiber ply 111, so that the connecting region 1133 and the first carbon fiber ply 111 actually form an integrated continuous structure. It can also be understood that the first carbon fiber ply 111 is partially hollowed out and the second carbon fiber ply 113 is embedded in the hollow position. In this way, the connecting region 1133 on the second carbon fiber ply 113 is connected to the first carbon fiber ply 111, which improves the connection strength between the first carbon fiber ply 111 and the second carbon fiber ply 113, and improves the reliability of the overall structure.

It should be noted that, in the embodiment, a connecting region 1133 may be provided at the edge of the second carbon fiber ply 113 in the width direction. For example, connecting regions 1133 may be provided at the edges of both sides of the deformable section, and an elastic region 1131 may be provided between the two connecting regions 1133. Alternatively, two elastic regions 1131 may be provided side by side along the width direction of the carbon fiber structural member 10, and a connecting region 1133 may be provided between the two elastic regions 1131, both of which may serve to increase the connection strength between the deformable section and the fixed section.

It should also be noted that, in the embodiment of the present application, the carbon fiber structural member 10 may include at least two splicing plies 11, and the second carbon fiber plies 113 in some of the splicing plies 11 may include a connecting region 1133 and an elastic region 1131, or all second carbon fiber plies 113 may include a connecting region 1133 and an elastic region 1131, which is not limited here.

As shown in FIG. 16, in an embodiment of the present application, the second carbon fiber ply 113 includes two connecting regions 1133 and an elastic region 1131 provided between the two connecting regions 1133.

In the embodiment, the connecting region 1133 is provided at the edge of the deformable section in the width direction. In this way, the fixed section 15 and the deformable section 17 form an integrated structure at the edge, which can improve the edge strength of the carbon fiber structural member 10 and avoid damage to the edge of the carbon fiber structural member 10, thereby preventing the carbon fiber structural member 10 from being easily damaged and broken due to external damage.

As shown in FIG. 17, in an embodiment of the present application, the second carbon fiber ply 113 includes two elastic regions 1131 and an connecting region 1133 provided between the two elastic regions 1131.

In the embodiment, the connecting region 1133 is provided in the middle of the width direction of the deformable section, which can also improve the splicing strength of the fixed section 15 and the deformable section 17, and can improve the structural reliability of the deformable section 17. In addition, in an embodiment, when the deformable section 17 is provided with at least two second carbon fiber plies 113, the connecting region 1133 in a part of the second carbon fiber plies 113 is provided in the middle, so that it can be staggered with the other part of the second carbon fiber plies 113 in which the connecting region 1133 is provided at the edge, which can ensure the elasticity of the deformable section 17 while improving the reliability of the carbon fiber structure.

In an embodiment, at least two connecting regions 1133 and at least two elastic regions 1131 may be provided, so that the connecting regions 1133 and the elastic regions 1131 are alternately arranged along the width direction of the carbon fiber structural member 10, which is not limited herein.

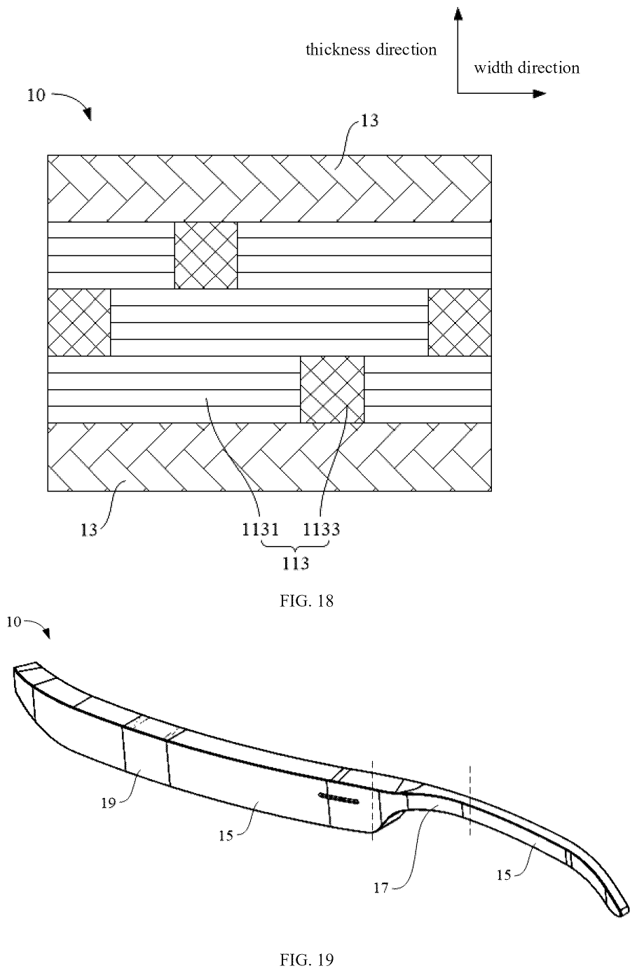

As shown in FIG. 18, in an embodiment of the present application, in the carbon fiber structural member 10, at least two second carbon fiber plies 113 include the elastic region 1131 and the connecting region 1133, and the connecting regions 1133 of the two second carbon fiber plies 113 are staggered.

In the embodiment, the carbon fiber structural member 10 is formed by stacking at least two splicing plies 11. Such a configuration can improve the structural strength of the carbon fiber structural member 10. In addition, the connecting regions 1133 provided on the second carbon fiber plies 113 in the two splicing plies 11 are staggered. It can be understood that due to the different layup angles of the carbon fibers on the connecting region 1133 and the elastic region 1131, the layup angle of the connecting region 1133 is the same as the layup angle of the first carbon fiber ply 111, resulting in a weaker bending performance and stronger anti-bending performance of the connecting region 1133. If the connecting regions 1133 of different second carbon fiber plies 113 are stacked, the anti-bending performance of each connecting region 1133 is superimposed, resulting in a reduced bending performance of the deformable section 17 and making it difficult to bend, If the connecting regions 1133 on the adjacent second carbon fiber plies 113 are staggered, the influence of the connecting region 1133 provided on the second carbon fiber ply 113 on the bending performance of the deformable section 17 can be reduced, and the reliability of the carbon fiber structure can be improved while ensuring the elasticity of the deformable section 17.

In addition, the splicing position between the elastic region 1131 and the connecting region 1133 in any second carbon fiber ply 113 is stacked with the elastic region 1131 in another second carbon fiber ply 113, thereby avoiding the second carbon fiber ply 113 from warping at the splicing position between the elastic region 1131 and the connecting region 1133, thereby improving the structural reliability.

In some embodiments of the present application, an accommodating cavity is formed in the fixed section 15.

The carbon fiber structural member 10 in the embodiment of the present application can be a structural member in the wearable device 100. An accommodating cavity can be provided in the fixed section 15 with strong strength and bending performance in the carbon fiber structural member 10, and some electrical components in the wearable device 100 can be provided in the accommodating cavity. Since the deformable section 17 in the carbon fiber structural member 10 is more easily bent and deformed, and the fixed section 15 has a better bending performance, damage to the internal electrical components can be avoided when the carbon fiber structural member 10 is bent. Taking the carbon fiber structural member 10 as the temple of VR glasses as an example, due to the differences in head shapes of different people, it is necessary to provide a deformable section 17 on the temple, so that the temple can be bent at the deformable section 17 to adapt to users with different head sizes. In the VR glasses, it is also necessary to arrange a computing unit, acoustic components and charging ports, etc., so it is necessary to make at least one section of the temple have a certain rigidity and not allow deformation, so as to be used for installing computing units, acoustic components and charging ports and other electrical components. At this time, the front end and the rear end of the temple can be set as the fixed section 15, and the middle of the temple can be set as the deformable section 17, so that the temple can have a certain deformation amount to suit different users, and can also avoid damage to electrical components to ensure stable performance.

In an embodiment, the wall thickness of the carbon fiber structural member 10 is made to be no more than 0.5 mm, so as to ensure the strength of the carbon fiber structural member 10 while avoiding the carbon fiber structural member 10 being too large in size, thereby meeting the requirements of light weight and small volume.

As shown in FIG. 19, in an embodiment of the present application, the side wall of the fixed section 15 is provided with an opening communicated with the accommodating cavity. The carbon fiber structural member 10 also includes a wave-transmitting material layer 19. The wave-transmitting material layer 19 covers the opening of the accommodating cavity.

In an embodiment, the wearable device 100 has a wireless communication function, and a wireless communication device such as an antenna or Bluetooth is provided in the accommodating cavity of the fixed section 15, but the carbon fiber ply has good conductivity and electromagnetic shielding performance, which will hinder the transmission of electromagnetic signals. In the embodiment of the present application, an opening communicated with the accommodating cavity is opened on the side wall of the fixed section 15, and the opening is closed by a wave-transmitting material layer 19. Such a setting can maintain the closure of the accommodating cavity to prevent foreign objects from entering the accommodating cavity or internal electrical devices from falling out of the accommodating cavity, and a signal passing area can be formed at the position of the wave-transmitting material layer 19, and the electromagnetic signal can pass through the wave-transmitting material layer 19, thereby not affecting the wireless communication function of the wearable device 100. The wave-transmitting material layer 19 can be made of one or more of glass fiber, silicon dioxide, glass ceramics, silicon nitride, boron nitride, etc., which are not limited here.

As shown in FIG. 19 to FIG. 22, the present application also proposes a wearable device 100, including a carbon fiber structural member 10 as described in any of the aforementioned embodiments. The wearable device 100 proposed in the present application can be a head-mounted device or a wristband device. In addition, it can be an electronic device such as a virtual reality device, an augmented reality device, a mixed reality device, and a headset, or a wearable product such as myopia glasses and sunglasses. The wearable device 100 includes but is not limited to glasses, masks, or helmets.

The wearable device 100 includes the carbon fiber structural member 10 proposed in any of the aforementioned embodiments of the present application. The carbon fiber structural member 10 can be the temples and frames of glasses, the nose rests of glasses, masks or helmets, the headband of headphones, or the wristband of wrist-worn devices. It can also be the internal structural member of the temple or other structural members with deformation requirements in the wearable device 100, which are not limited here.

Since the wearable device 100 proposed in the present application applies all the technical solutions of all the aforementioned embodiments, it at least has all the beneficial effects brought by all the aforementioned technical solutions, which will not be described one by one here.

The above contents are only some embodiments of the present application, and do not limit the scope of the present application. All equivalent structural changes made by using the contents of the present application specification and drawings under the inventive concept of the present application, or directly/indirectly applied in other related technical fields are included in the scope of the present application.

What is claimed is:

1. A carbon fiber structural member, comprising:
a fixed section;
a deformable section connected with the fixed section along a longitudinal direction of the carbon fiber structural member; and
at least one splicing ply, the splicing ply comprising a first carbon fiber ply provided in the fixed section and a second carbon fiber ply provided in the deformable section;
wherein carbon fibers of the second carbon fiber ply are perpendicular to the longitudinal direction of the carbon fiber structural member, and the first carbon fiber ply in the at least one splicing ply is a carbon fiber woven material or carbon fibers of the first carbon fiber ply are extended at least along the longitudinal direction of the carbon fiber structural member.

2. The carbon fiber structural member according to claim 1, further comprising:
at least one carbon fiber continuous layer;
wherein the carbon fiber continuous layer is provided on a surface of at least one side of the carbon fiber structural member.

3. The carbon fiber structural member according to claim 2, wherein the carbon fiber structural member comprises two carbon fiber continuous layers, and the splicing ply is sandwiched between the two carbon fiber continuous layers.

4. The carbon fiber structural member according to claim 1, wherein the carbon fiber structural member comprises two splicing plies, and splicing positions of two adjacent splicing plies are staggered.

5. The carbon fiber structural member according to claim 4, wherein the carbon fiber structural member comprises at least three splicing plies, one of the splicing plies is sandwiched between other splicing plies and serves as a middle splicing ply, and splicing positions of each of the splicing plies at either side of the middle splicing ply are sequentially staggered toward a side of the second carbon fiber ply; or
the splicing positions of the splicing plies are sequentially staggered along the longitudinal direction of the carbon fiber structural member.

6. The carbon fiber structural member according to claim 1, wherein at least a portion of a splicing boundary between the first carbon fiber ply and the second carbon fiber ply is provided at an angle to a width direction of the splicing ply.

7. The carbon fiber structural member according to claim 6, wherein one of the first carbon fiber ply and the second carbon fiber ply is provided with a splicing interface, and another of the first carbon fiber ply and the second carbon fiber ply is provided with a splicing portion that matches a shape of the splicing interface, and the splicing portion is embedded in the splicing interface.

8. The carbon fiber structural member according to claim 7, wherein the splicing interface is provided with a shrinking section, and the shrinking section is in a shrinking state toward an opening of the splicing interface.

9. The carbon fiber structural member according to claim 1, wherein layup angles of the first carbon fiber layers in two adjacent splicing plies are different.

10. The carbon fiber structural member according to claim 1, wherein the second carbon fiber ply of the at least one splicing ply comprises at least one elastic region and at least one connecting region provided along a width direction; carbon fibers in the elastic region are perpendicular to the longitudinal direction of the carbon fiber structural member, and a layup angle of the connecting region is the same as the layup angle of the first carbon fiber ply.

11. The carbon fiber structural member according to claim 10, wherein at least two second carbon fiber plies comprise the elastic region and the connecting region, and the connecting regions of the two second carbon fiber plies are staggered; and/or
the second carbon fiber ply comprises two connecting regions and the elastic region provided between the two connecting regions; and/or
the second carbon fiber ply comprises two elastic regions and the connecting region provided between the two elastic regions.

12. The carbon fiber structural member according to claim 1, wherein an accommodating cavity is formed in the fixed section.

13. The carbon fiber structural member according to claim 12, wherein a side wall of the fixed section is provided with an opening communicated with the accommodating cavity, and the carbon fiber structural member further comprises a wave-transmitting material layer for covering an opening of the accommodating cavity.

14. A wearable device, comprising:
the carbon fiber structural member according to claim 1.
